(19) United States
(12) Patent Application Publication
(10) Pub. No.: US 2009/0161196 A1
(43) Pub. Date: Jun. 25, 2009

(54) SYSTEM AND METHOD FOR SPECKLE REDUCTION FROM A COHERENT LIGHT SOURCE IN A PROJECTION DEVICE

(75) Inventor: KOEN MALFAIT, Roeselare (BE)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: BARCO NV, KORTRIJK (BE)

(21) Appl. No.: 11/961,085

(22) Filed: Dec. 20, 2007

(51) Int. Cl. G02B 26/06

(52) U.S. Cl. 359/290

(57) ABSTRACT

Embodiments of the present invention are directed to a system and method for reducing speckle phenomenon caused by a coherent light source. Particular embodiments of the present invention are directed to a system and method for temporally varying the interference pattern generated by a coherent light source to homogenize the speckle pattern so that the speckle phenomenon is less observable. In accordance with an exemplary embodiment, an oscillating refractive element may be disposed within an optical system to create a temporally variable phase shift in the lights rays emanating from a coherent light source to eliminate static interference patterns on a light receiving element, reducing the speckle phenomenon.

### BACKGROUND OF THE INVENTION

1. Technical Field

The present invention relates to a system and method for speckle reduction from a coherent light source in a light projection device.

2. Description of Related Art

A new generation of projection devices is emerging, in which conventional arc lamps are replaced by other technologies, such as light emitting diodes (LEDs) and lasers. LED and laser light sources have significant advantages over conventional arc lamps.

The efficiency of LEDs has improved substantially during the last decade increasing the lifespan of LED devices, making LEDs an economically valuable alternative to conventional lamps. In addition, the spectral characteristics of LEDs produce more saturated colors than a white arc lamp, which requires dividing the light spectrum to produce the three primary colors. The ability to modulate LEDs is also advantageous because it allows color sequential illumination in projection devices while employing a single light modulator. Further, the ability to dim LEDs enables generating high dynamic contrast ratios in a projection device.

Laser light sources provide the benefits of LEDs described above, as well as additional advantages. Laser light sources produce dramatically greater color saturation because the monochromatic nature of laser light creates perfect saturation of the primary colors.

Further, the étendue value of a laser light source is significantly smaller than present in lamps or LEDs, in many instances approaching zero. The étendue value characterizes how “spread out” light from a source is in area and angle. The étendue of a laser light source is exceptionally small because of the laser's very small emitting surface, and very small opening angle.

Optical components may also effect the étendue of a light beam. The properties and physics of light, however, dictate that the étendue of a light beam can never be reduced without the beam losing intensity. The étendue of a light beam may effect its ability to interact with the components of an optical system in a desired manner. For example, a light modulator may consists of 1920×1080 small mirrors which can flip around their diagonal to achieve three positions: +12; −12; and 0 degrees. Therefore, an incident light beam can only be separated by the modulator if the opening angle is less than 24 degrees. Laser light sources have an exceptionally small étendue and emitting surface, enabling a light beam from a plurality of lasers to be accommodated by the surface of a single modulator.

An additional advantage of lasers is their ability to be intermitantly switched on and off, enabling enhanced modulation of the light source. Further, the fixed polarization state of laser light beams allows lasers to be used with projection devices employing light valves that require polarized incident light. Such light valves may comprise liquid crystal display, liquid crystal on silicon elements, or digital light processing display.

A complication with laser light sources arises from the coherent nature of the light beams. The light rays in a laser beam propagate in phase. The coherence of laser beams creates a speckle artifact upon interacting with a surface. This speckle pattern is caused by the dual nature of light. Light travels in waves and interacts with matter as a particle. When multiple light rays arrive at the same point on a surface in phase, the waves constructively interfere producing increased intensity. When the waves arrive out of phase by half a wavelength destructive interference occurs causing the light rays to cancel each other out. Multiple interference effects may be present on a surface. At positions on the surface where constructive interference occurs, a bright spot is witnessed. At positions where destructive interference occurs, no light is observed. The resulting is a speckled pattern is referred to as the speckle phenomenon.

A conventional technique to reduce the speckle phenomenon is to destroy the coherence of the light by using an electrophoretic diffuser (e.g. US20070058135, 30 EP1510851). The electrophoretic diffuser comprises electrophoretic elements in an aqueous solution, which are vibrated by applying an alternating current to electrodes disposed at opposite ends of the diffuser. The aqueous solution of electrophoretic elements scatters the light rays, altering the direction of propagation of the rays. Movement of the electrophoretic elements ensures that the change in direction of propagation will vary temporally, resulting in a temporally homogenized interference pattern. Consequently, the interference pattern will be less observable since it is no longer a static phenomenon.

A major disadvantage to this technique is that the electrophoretic diffuser substantially increases the étendue of a light beam and alters the polarization state of the light rays. Consequently, the diffuser is impractical or completely incompatible with certain optical systems. Therefore, a need remains for a system and method for reducing speckle phenomenon produced by a laser light source without increasing the étendue of a light beam or effecting the polarization state of the light rays.

### BRIEF SUMMARY OF THE INVENTION

Embodiments of the present invention are directed to a system and method for reducing speckle phenomenon caused by a coherent light source. Particular embodiments of the present invention are directed to a system and method for temporally varying the interference pattern generated by a coherent light source such that it may be homogenized by the human eye resulting in a less observable speckle phenomenon. In accordance with an exemplary embodiment, an oscillating refractive element may be disposed within an optical system to create a temporally variable phase shift in the lights rays emanating from a coherent light source to eliminate static interference patterns on a light receiving element, reducing the speckle phenomenon.

An exemplary embodiment of the present invention is a refractive device comprising: a refractive element having a geometric configuration and refractive properties such that the propagation axis of a light ray exiting the refractive element is approximately parallel to the propagation axis of the ray entering the refractive element and two or more rays refracted by the refractive element undergo relative phase shift; and an oscillating element translating or rotating the refractive element relative to the propagation axis of rays entering the element. In accordance with this exemplary embodiment, the propagation axis of light rays exiting the refractive element is not exactly parallel to the propagation axis of rays entering the element or else the rays would not undergo the desired phase shift.

An another exemplary embodiment of the present invention is a system for inducing temporally varying relative phase shift in rays emanating from a coherent light source, the system comprising: a coherent light source for emanating a coherent beam of light; a light valve having a plurality of pixels; a refractive element having a geometric configuration and refractive properties such that the propagation axis of a light ray exiting the refractive element is approximately parallel to the propagation axis of the ray entering the refractive element and two or more rays refracted by the refractive element undergo relative phase shift; and an oscillating element translating or rotating the refractive element relative to the propagation axis of rays entering the refractive element.

A further exemplary embodiment of the present invention is a method for inducing temporally varying relative phase shift in rays emanating from a coherent light source, comprising: emanating a coherent light beam from a coherent light source along an axis of propagation; refracting the coherent light beam emanating from the coherent light source using a refractive element such that the propagation axis of a light ray exiting the refractive element is approximately parallel to the propagation axis of the ray entering the refractive element and two or more rays refracted by the refractive element undergo relative phase shift; translating or rotating the refractive element relative to the propagation axis of rays entering the element; and receiving the light beam at a light receiving element, wherein the light beam creates an interference pattern on the surface of the light receiving element, the interference pattern varying temporally due to the translation or rotation of the refractive element.

These and other features as well as advantages, which characterize various exemplary embodiments of the present invention, will be apparent from a reading of the following detailed description and a review of the associated drawings.

### BRIEF DESCRIPTION OF THE DRAWINGS

FIG. 1a illustrates an exemplary embodiment of a refractive system having a refractive element.

FIG. 1b illustrates measurements from a phase detector located between a light source and a refractive element.

FIG. 1c illustrates measurements from a phase detector located between a refractive element and a light receiving element.

FIG. 1d illustrates a refractive system wherein light rays pass through a refractive element having continually varying width according to an exemplary embodiment of the present invention.

FIG. 1e illustrates the measurement of the light rays 110 at a phase detector perpendicular to propagation axis 111 located between the refractive element 130d and light receiving element 140.

FIG. 2 illustrates a refractive element according to a preferred embodiment of the present invention.

FIG. 3 illustrates a refractive element having two components according to a preferred embodiment of the present invention.

FIG. 4 illustrates an optical system according to a preferred embodiment of the present invention.

FIG. 5 illustrates a flowchart of method for inducing temporally varying relative phase shift in rays emanating from a coherent light source according to an exemplary embodiment of the present invention.

### DETAILED DESCRIPTION OF PREFERRED EMBODIMENTS

A light ray can be represented as an electromagnetic wave with an electrical field component E and a magnetic field component B. From the wave equation a sinusoidal solution is found, E=E₀ sin(ωt−kx), with an angular frequency ω=2πf=2π c/nλ and a wave number k=2π/λ. The speed of light is designated by c and the refractive index of the material the wave is propagating through is designated by n. The wavelength of the electromagnetic ray is designated by λ. It can be derived that λ=λ₀/n where λ₀ is the wavelength of a light ray in a vacuum, which closely approximates the wavelength of light in air.

In crown glass, such as BK7, the refractive index n is equal to 1.52, reducing the wavelength λ of light by one third (⅓). As a result, the peaks of the wave are closer together and light travels slower through the material. The principles above describe how the wavelength of a light ray is dependent upon the refractive index of the material through which it propagates. This particular property of light is employed to induce phase shift in the rays of a light beam in the embodiments of the present invention described below.

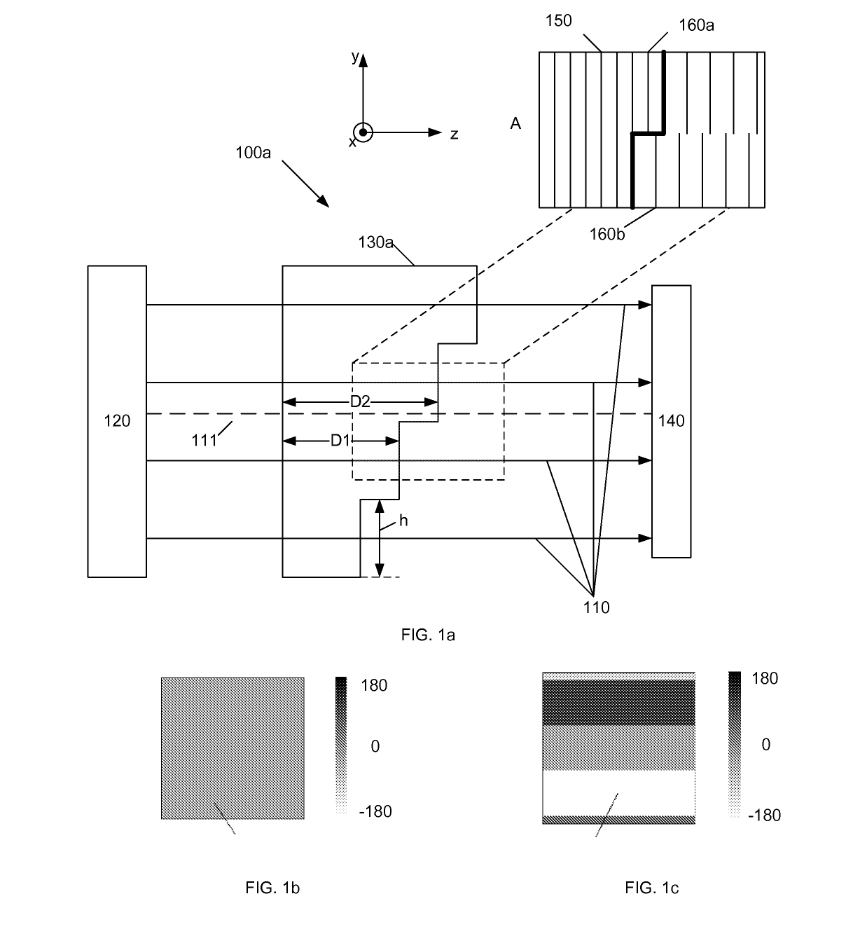

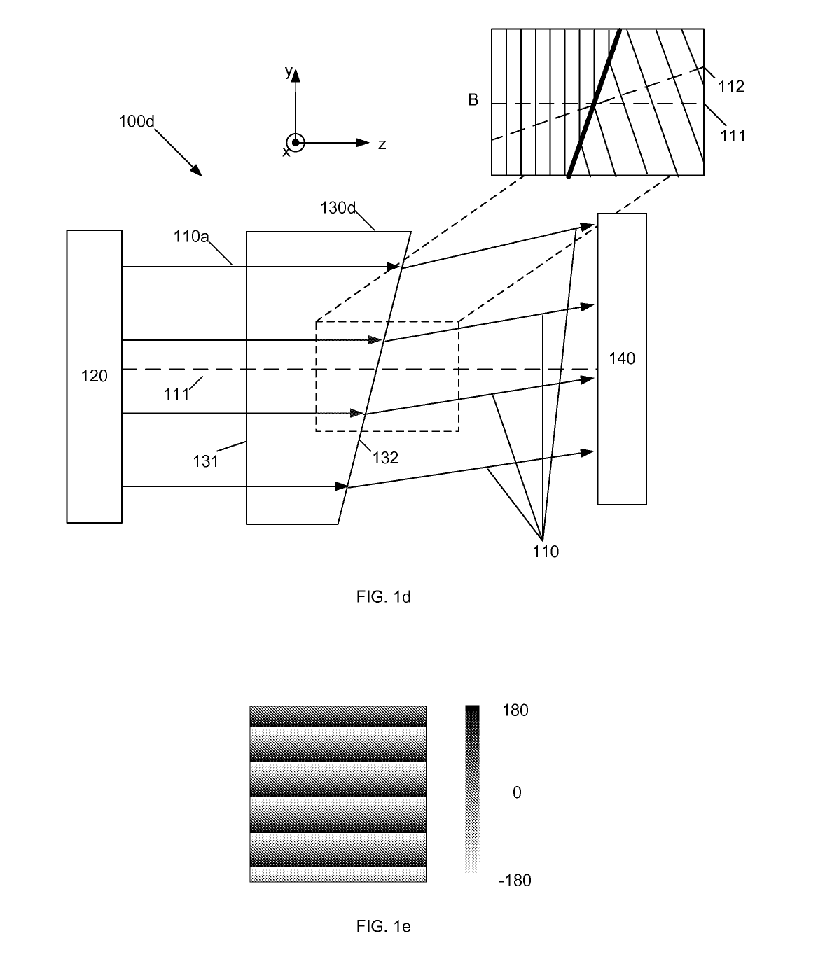

Referring now in detail to the drawing figures, wherein like reference numerals represent like parts throughout the several views, FIG. 1a illustrates an exemplary embodiment of a refractive system 100a having a refractive element 130a. A plurality of parallel light rays 110 preferably emanate from a common light source 120. An exemplary light source may be a laser light source. The rays 110 preferably travel through air prior to reaching a refractive element 130a. The rays 110 preferably propagate substantially parallel to a propagation axis 111. The refractive element 130a may be composed of a refractive material such as glass, plastic, or another material with a suitable index of refraction n. The refractive element 130a is preferably transparent or translucent, having a minimal opacity, to the frequency of light being used. The angle of incidence of the light rays 110 is preferably substantially zero (0) degrees. In other contemplated embodiments of the invention discussed in greater detail below, the angle of incidence of the light rays to the refractive element may be an angle greater or less than zero (0) degrees.

The refractive element 130a preferably has a stair-like shape such that its width varies incrementally along one of its sides. The refractive element 130a preferably has at least a first width of distance d₁ and a second width of distance d₂, wherein d₁ is less than d₂. Consequently, as light rays 110 pass through the refractive element 130a, certain rays will travel a distance d₁ whereas others will travel a distance d₂. After passing through the refractive element 130a, the rays 110 preferably travel through air approximately parallel to propagation axis 111 before reaching a light receiving element 140. The rays 110 preferably display a pattern or image on the light receiving element 140.

Approximately parallel as used herein means that the refracted rays propagate nearly parallel to the propagation axis of the incident rays, but not exactly parallel to said axis. Preferably the angle between the propagation axis of the refracted and the propagation axis of the incident rays is less than 0.1 degree and greater than zero degrees. More preferably the angle between the propagation axis of the refracted and the propagation axis of the incident rays is less than 0.05 degrees and greater than zero. Most preferably the angle between the propagation axis of the refracted and the propagation axis of the incident rays is less than 0.03 degrees and greater than zero.

In general, wave fronts of rays of a coherent light source, such as light source 120, propagate in unison. The wave fronts leaving the light source 120 together and arrive at the light receiving element 140 at the same time. This occurs because the wave fronts travel the same distance at the same speed. Placing the refractive element 130a between the light source 120 and light receiving element 140 does not change the total distance the rays 110 travel, but does change the distance the rays travel through the refractive element 130a. Since the refractive element 130a has an index of refraction greater than air, the rays 110 will travel slower through the refractive element 130a than through air. Consequently, wave fronts that travel a greater distance through the refractive material will reach the light receiving element 140 after wave fronts that travel a shorter distance. The result is that the waves fronts traveling different distances through refractive material will no longer be in phase. At least one of the geometric configuration, the refractive index, and the dimensions including of the refractive element 130a are preferably optimized to achieve a desired degree or phase shift.

Inset A illustrates the phase shift of rays 110 traveling through the refractive element 130a as the rays exit the refractive element 130a. The line 150 represents the wave fronts of adjacent rays 110 propagating together, in phase, and at the same speed through the refractive element 130a. Lines 160a and 160b represent the wave fronts of rays that were previously in phase. The wave fronts at 160b have exited the refractive element 130a and travel at a greater speed than the wave fronts at 160a, which remain in the refractive element 130a. As a result, wave fronts at 160b have traveled a greater distance than wave fronts at 160a in the same amount of time, and are no longer propagating in phase. In this manner, the refractive element 130a causes a phase shift in the rays 110 that propagate through it.

FIGS. 1b and c illustrate measurements from two phase detectors. FIG. 1b illustrates measurements from a phase detector located between the light source 120 and the refractive element 130a. The rays 110 have not been refracted or phase shifted, and no phase differences in the waves are detectable. The amplitude of the wave of each ray detected by the phase detector is approximately equal. Phase shift does not change the maximum amplitude of the rays. Phase shift does, however, vary the observed amplitude at a point in time of rays that are phase shifted relative to other rays. For example, a first ray may be detected a point in time when its amplitude is close to its maximum amplitude, while the detected amplitude of a second ray, phase shifted with respect to the first ray, will be different from the detected amplitude of the first ray depending on the degree of phase shift. FIG. 1c illustrates measurements from a phase detector located between the refractive element 130a and the light receiving element 140. Clear bands are evident demonstrating that the rays traveling different distance though the refractive element 130a pass through the phase detector at different phases. Consequently, different amplitudes for the phase shifted rays are detected.

The above described embodiment assumes that the refractive index of refractive element 130a is greater that that of the surrounding medium. In particular, the embodiment assumes that the refractive element 130a is surrounded by air and is comprised of glass or another suitable material having a refractive index greater than 1, the refractive index of air. In other contemplated embodiments, the refractive index of the refractive element 130a is different from the surrounding medium, although not necessarily greater. For example, the surrounding medium may be a fluid and the refractive element 130a may have a refractive index smaller than that of the fluid. In other contemplated embodiments, an exotic of metamaterial can preferably be employed having an index of refraction that is less than the index of refraction or air or may even be negative.

Unfortunately, the refractive element 130a, as shown in FIG. 1a, will not eliminate speckle phenomenon in a projection device. The light receiving element 140 and various intermediary optical components exhibit light diffusing properties. Further, light rays 110 do not propagate exactly parallel relative to each other or the propagation axis 111. Therefore, shifting the phase of light rays 110 will merely produce a different random interference pattern on the light receiving element 140.

In accordance with an exemplary embodiment of the present invention, the interference pattern is preferably constantly and randomly varied, thereby reducing its visibility to the human eye. In an exemplary embodiment, the interference pattern on a surface at time t1 is different than the pattern on the surface at time t2. Preferably t2−t1<<20 ms. The approximate sampling rate of the human eye is 50 Hz (20 ms). Therefore, the human eye would not be able to detect two distinct interference patterns that are displayed less the 20 ms apart, and patterns would be averaged or homogenized. The following equation illustrates the observed interference (“I”) as averaged by the human eye over time from multiple distinct interference patterns displayed less than 20 ms apart:

$${I}_{t} = {\int }_{t - 0.02}^{t} {I}_{t - t + dt} d t .$$

In an exemplary embodiment, the present invention provides a refractive element that is preferably translated and/or rotated to temporally vary the degree of phase shift in respective light rays of a coherent beam. By varying the degree of phase shift of respective light rays, the manner in which they interfere upon a surface is varied, resulting in an interference pattern that varies temporally. The translation of the refractive element may preferably occur along at least one of the x- and y-axis of an orthogonal coordinate where the z-axis preferably corresponds to the direction of propagation of the light rays entering the refractive element. Rotation of the refractive element can preferably occur about the z-axis such that the rotational axis of the refractive element is substantially parallel to the z-axis. In further contemplated embodiments, the refractive element can preferably translate along the x- and y-axis and rotate about the z-axis. In further preferred embodiments, at least one of the translation and rotation can preferably be random or irregular.

To combine the exemplary embodiment of refractive element 130a with the exemplary embodiment of an translating or rotating refractive element described above requires specific parameters of related to the geometry of the element. If the translation is relatively small compared to the height of the stairs h, translating the refractive element 130a would only effect rays that travel through the element close to the discrete transition regions where the width of the refractive element 130a changes. Those rays further from such transition regions would be unaffected by the translation, and would essentially propagate through a static system. Therefore, for the translation to produce substantial phase shift, the amplitude of oscillation must be greater than h, preferably substantially equal to 2h, which may be impractical or impossible. An exemplary embodiment, as described below, solving this problem reduces height h until a smooth, sloped surface is achieved, eliminating the transition regions.

Rotating the refractive element requires a particular alignment of the rotational axis. The rotational axis is preferably substantially parallel to the propagation axis of the rays entering the refractive element, otherwise the angles of incidence of the rays would vary as the refractive element is rotated. Consequently, the rays exiting the refractive element would not propagate about an axis that is approximately parallel to the propagation axis of the rays entering the element. Additionally, the rotation axis must be substantially close to the propagation axis of the lights rays so that the refractive element does not rotate out of the path of the incident light rays. Due to the discrete transition regions created by the stairs, the angle of rotation would have to be large enough such that a ray entering the refractive element does not constantly pass through the same stair region, but alternate between at least two stair regions during the rotational cycle of the refractive element.

FIG. 1d illustrates a refractive system 100d wherein light rays pass through a refractive element 130d having continually varying width according to an exemplary embodiment of the present invention. The refractive element 130d preferably has a first planar surface 131 and a second planar surface 132, which are not parallel relative to each other. As a result, the width of the refractive element 130d varies continually, increasing from the bottom to the top of the element 130d. The second planar surface 132 may be considered analogous to an infinite number of stairs as those depicted in refractive element 130d. Similar to system 100a, a light source 120 generates coherent rays 110 that propagate parallel to a propagation axis 111 and pass through a refractive element 130d.

The varying width of the refractive element 130d, however, does not causes a phase shift in the wave fronts of adjacent rays 110 with respect to their refracted propagation axis 112. As shown in Inset B, the rays 110 are refracted according to Snell's Law due to the different refractive indexes of air and the refractive element 130d, and rays 110 continue to travel coherently, without detectable phase shift along a refracted propagation axis 112 that is at an angle to the original propagation axis 111. The rays 110 are out of phase, however, with respect to the original propagation axis 111. FIG. 1e illustrates the measurement of the light rays 110 at a phase detector perpendicular to propagation axis 111 located between the refractive element 130d and light receiving element 140. The measurement indicates that the rays 110 are out of phase with respect to the original propagation axis 111. The light receiving element 140 is preferably oriented perpendicular to the propagation axis 111, resulting in the rays 110 interacting with the surface of the light receiving element 140 out of phase.

In accordance with an exemplary embodiment, the refractive element 130d can preferably be translated and/or rotated relative to the x-, y-, and z-axis. The translation and rotation can be irregular or random. The translation and rotation will induce a phase shift in adjacent rays that varies temporally as described above in relation to FIG. 1a. However, translation of the refractive element 130d in certain directions relative to the x- and y-axis will not vary the degree of phase shift between two respective rays. For example, if the refractive element 130d is translated only relative to the x-axis, the propagation path of rays 110 through refractive element will not change, and the relative phase shift of the rays will remain unchanged. If the refractive element 130d is translated only relative to the y-axis, the propagation path of each of the rays 110 will change equally and the rays 110 will not undergo a phase shift relative to each other. Consequently, the degree of phase shift between rays 110 will remain constant and the interference pattern will not change.

Refractive element 130d is preferably translated along both the x- and y-axis. Translation along both the x- and y-axes results in a change in the difference between the distances traveled by respective rays. Consequently, the degree of phase shift between respective rays will also vary. Preferably at least one of the direction or distance of the translation along both the x- and y-axes is varied randomly as a function of time, resulting in the degree of phase shift between respective rays preferably varying temporally. Accordingly, the interference pattern at light receiving element 140 preferably will also vary temporally and be homogenized by the eye, resulting in a reduction in the observable speckle phenomenon.

The refractive element 130d illustrated in FIG. 1d is a two dimensional (2D) rendering. In all implementations of the exemplary embodiments of the present invention, the refractive element is three dimensional (3D). The first planar surface 131 defines a first plane. The second planar surface 132 defines a second plane. The first planar surface 131 and second planar surface 132 preferably are not parallel. Consequently, the first plane and the second plane intersect at a first line. The translation described above along both the x- and y-axis is preferably preformed by translating the refractive element 130d in a direction that is preferably not parallel or perpendicular to the first line. Translation parallel or perpendicular to the first line would be equivalent to translation along only the x- or y-axis described above, and would not result in varying the degree of phase shift between respective rays.

Rotation of the refractive element 130d about a rotational axis preferably substantially parallel to the propagation axis 111 will result in a change in the difference between the lengths of the propagation paths of the rays 110 through the refractive element 130d. Consequently, the degree of phase shift between respective rays will vary with the rotation of the refractive element 130d. Therefore, the interference pattern will preferably vary temporally in relation to the rotation of the refractive element 130d. The varying interference pattern is preferably homogenized by the human eye, and the appearance of the speckle phenomenon is substantially reduced.

The exemplary embodiment described in FIG. 1d has several drawbacks. First, the rays exiting the refractive element 130d travel about a refracted propagation axis 112 that is not parallel to the original propagation axis 111. This is undesirable in systems that rely on rays propagating along an axis parallel to the original propagation axis 111. Second, refractive element 130d distorts the preferably symmetric telecentricity of light rays used in a projection system. Light rays do not propagate perfectly parallel, and thus their respective angle of incidence to slope 131 varies, resulting in varying respective angles of refraction. Consequently, the angles between respective rays are altered after exiting the refractive element 130d, destroying their symmetric behavior.

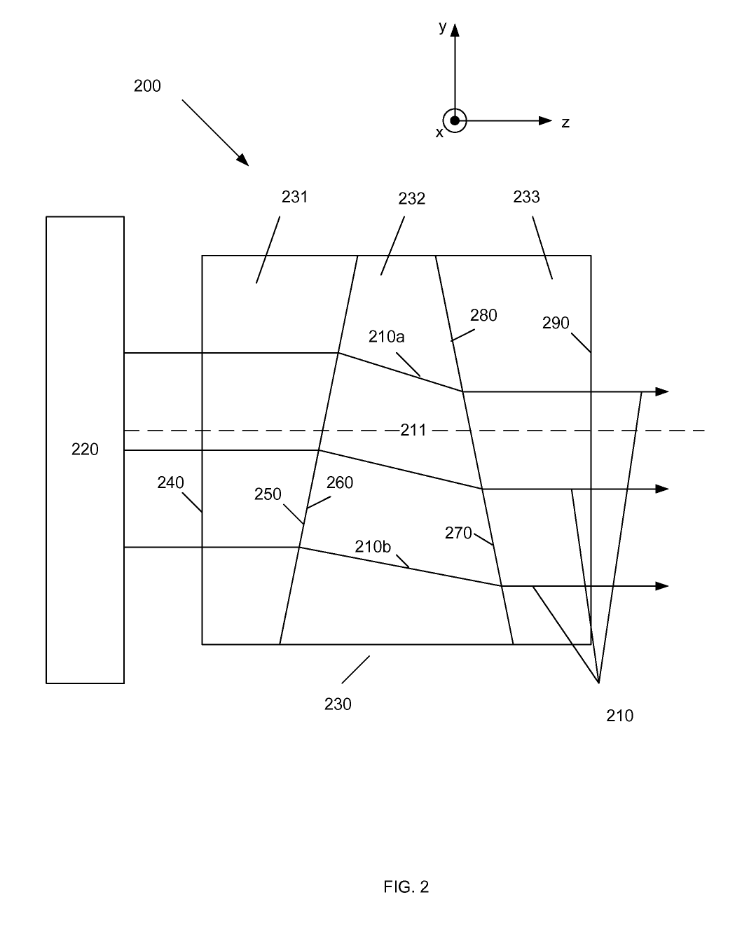

In accordance with an exemplary embodiment the presenting invention, the refractive element comprises two or more components. The geometric arrangement and refractive indexes of the components are preferably selected and optimized to induce phase shift between respective light rays while maintaining a propagation axis upon exiting the refractive element that is parallel to the propagation axis of the rays upon entering the refractive element. FIG. 2 illustrates a refractive element 230 according to a preferred embodiment of the present invention. The refractive element 230 preferably comprises a first component 231, a second component 232, and a third component 233.

The first component 231 preferably has a first planar surface 240 and a second planar surface 250. The first planar surface 240 preferably defines a first plane and the second planar surface 250 preferably defines a second plane. The first and second planes are preferably not parallel. The second component 232 preferably has a third planar surface 260 and a fourth planar surface 270. The third planar surface 260 preferably defines a third plane and the fourth planar surface 270 preferably defines a fourth plane. The third and fourth planes are preferably not parallel. The third component 233 preferably has a fifth planar surface 280 and a sixth planar surface 290. The fifth planar surface 260 preferably defines a fifth plane and the sixth planar surface 290 preferably defines a sixth plane. The fifth and sixth planes are preferably not parallel. The second and third planes are preferably parallel. Similarly, the fourth and fifth planes are preferably parallel. In other contemplated embodiments, the angles between the planes may be varied and different planes may be parallel or not parallel to other respective planes.

The second planar surface 250 preferably abuts the third planar surface 260. Similarly, the fourth planar surface 270 preferably abuts the fifth planar surface 280. The components 231, 232, and 233 may be optically bonded or attached by glue, cement, or another suitable bonding means. At least one of the geometric configuration including the respective angles between planar surface 240, 250, 260, 270, 280, and 290, the refractive indexes, and the dimensions including the width of components 231, 232, 233 are preferably optimized to achieve a desired degree of phase shift and maintain the propagation axis of the rays 210 exiting the refractive element 230 approximately parallel to the propagation axis 211 of the rays entering the refractive element 230. However, to achieve the desired degree of phase shift, it is preferred that the propagation axis of the rays 210 exiting the refractive element 230 is not exactly parallel to the propagation axis 211 of the rays entering the refractive element 230. In fact, manufacturing a refractive element capable of sufficient precision that would enable the rays exiting a refractive element to propagate exactly parallel to the propagation axis of the rays entering the refractive element would require tolerances that presently may not be attainable.

The refractive element 230 is preferably disposed within the optical system of a projection device. A light source 220 preferably emanates a coherent light beam comprising a plurality of rays 210. The light source 220 is preferably a laser light source or another suitable source capable of emanating a coherent light beam. The rays preferably travel coherently, parallel to a propagation axis 211 prior to arriving at the first component 231 of the refractive element 230. The angle of incidence of the rays 210 upon entering the first component 231 at the first planar surface 240 is preferably approximately zero. Consequently, the rays 210 are preferably not refracted upon entering the first component 231 and continue to travel parallel to the propagation axis 211.

The rays exit the first component 231 and enter the second component 232 at the juncture of the second planar surface 250 and third planar surface 260. The second and third planar surfaces are preferably at an angle relative to the propagation axis 211 of the rays 210, hence the angle of incidence of the rays 210 is not zero, resulting in the rays 210 being refracted. Consequently, the rays 210 travel through the second component along a propagation axis at an angle to the propagation axis 211 according to the degree of refraction. The geometry of the second component 232 preferably results in a varying optical path length for respective rays 210. For example, the optical path length of ray 210a through the second component is preferably less than the path length of 210b.

The rays exit the second component 232 and enter the third component 233 at the juncture of the fourth planar surface 270 and fifth planar surface 280. The fourth and fifth planar surfaces 270 and 280 are preferably at an angle relative to the defracted propagation axis of rays 210 through the second component 232, hence the angle of incidence of the rays is not zero, resulting in the rays 210 again being refracted. The angle of refraction at the juncture of the fourth planar surface 270 and fifth planar surface 280 is preferably substantially the opposite the angle refraction at the juncture of the second planar surface 250 and third planar surface 260. Consequently, the rays 210 substantially return to their original propagation axis 211 as they travel through the third component 233. Upon exiting the third component 233, the angle of incidence of the rays 210 to the sixth planar surface is preferably substantially zero. Therefore, the rays 210 are not refracted and continue to travel approximately parallel to the propagation axis 211.

Due to the varying optical path length of the rays 210 through refractive element 230, the rays 210 are respectively phase shifted upon exiting the element 230. For example, the optical path length of ray 210a through the refractive element 230 is greater than the optical path length of ray 210b. Consequently, because rays 210a and 210b traveled different distances and at different speeds, the rays will undergo a phase shift relative to their phase relation prior to entering the refractive element. Similarly, each of the separate rays 210 will undergo a phase shift relative to their phase relation to other rays prior to entering the refractive element.

In other contemplated embodiments of the invention, the refractive element 230 may comprise two or more components of varying geometric shapes. For example, the refractive element 230 may comprise two components having refractive indexes and angles selected to induce a phase shift and result in the rays propagating approximately parallel to their original propagation axis upon exiting the refractive element. In further contemplated embodiments, the orientation of the surfaces of the refractive element relative to the propagation axis of the light rays may vary, provided that the exiting rays propagate parallel to the original propagation axis. For example, the angle of incidence of the rays upon entering the refractive element may be other than approximately zero.

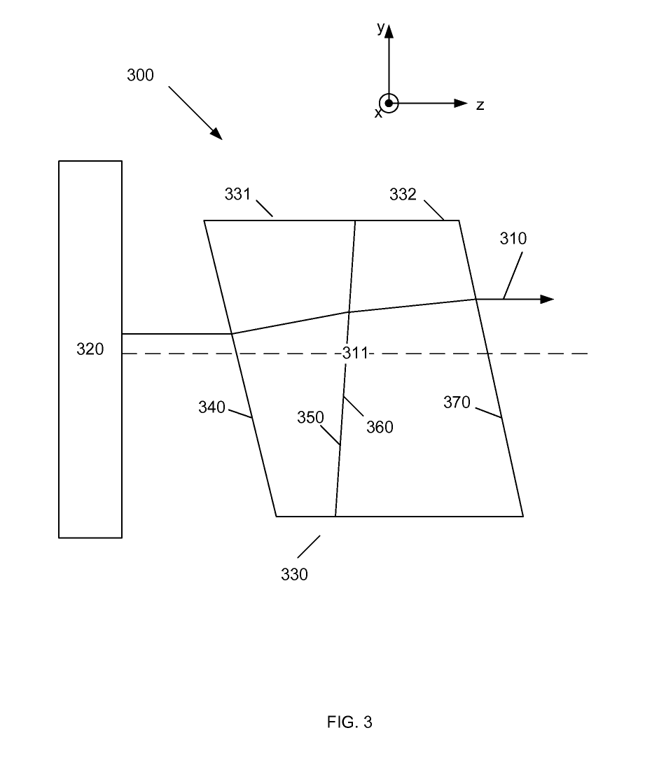

FIG. 3 illustrates a refractive element having two components according to a preferred embodiment of the present invention. The refractive element 330 comprises a first component 331 and a second component 332. For illustrative purposes a single light ray 310 is depicted emanating from a coherent light source 320 propagating parallel to propagation axis 311. The first component 331 preferably comprises a first planar surface 340 and a second planar surface 350. The second component 332 preferably comprises a third planar surface 360 and a fourth planar 370. The first and third components 231 and 233 preferably abut the second component 232 at their respective planar surfaces. At least one of the planar surfaces 340, 350, 360, and 370 is not parallel with respect to at least one of the other surfaces. The first and second components 331 and 331 preferably have indexes of refraction selected to attain the desired phase shift and propagation axis of the refracted rays as described above in relation to FIG. 2.

The angle of incidence of the ray 310 to first planar surface 340 of the first component 331 is preferably not zero. Consequently, the ray 310 is refracted. Similarly, the ray 310 is preferably refracted at the juncture of the second planar surface 350 and third planar surface 360, and again upon exiting the second component 332 at the fourth planar surface 370 such that it propagates approximately parallel to propagation axis 311. At least one of the indexes of refraction of the first and second components 331 and 333 and respective angles of the planar surfaces 340, 350, 360, and 370 are selected to attain a desired degree of phase shift between rays passing through refractive element 330 and maintain the ray 310 propagating approximately parallel to the propagation axis 311.

In further contemplated embodiments, the components of the refractive element may not be in physical contact. For example, the component may be separated by air or another medium. In all contemplated embodiments, the propagation axis of the rays exiting the refractive element is approximately parallel to the propagation axis of the rays entering the element. The refractive element in of the exemplary embodiments of the invention beneficially preserves telecentric nature of the light beam because the rays exiting the refractive element propagate substantially parallel to the original propagation axis.

As previously mentioned, shifting the phase of the rays will not eliminate the speckle phenomenon. Regarding the above described embodiments, the refractive element 230, 330, or any other contemplated refractive element is preferably translated in a direction that is not parallel or perpendicular to the line defined by the intersection of at least two planes defined by two planar surface of the refractive element. The refractive element as described above may alternatively or additionally be rotated such that the axis of rotation of the refractive element is substantially parallel to the propagation axis 111, 211 or 311 of the incident light rays.

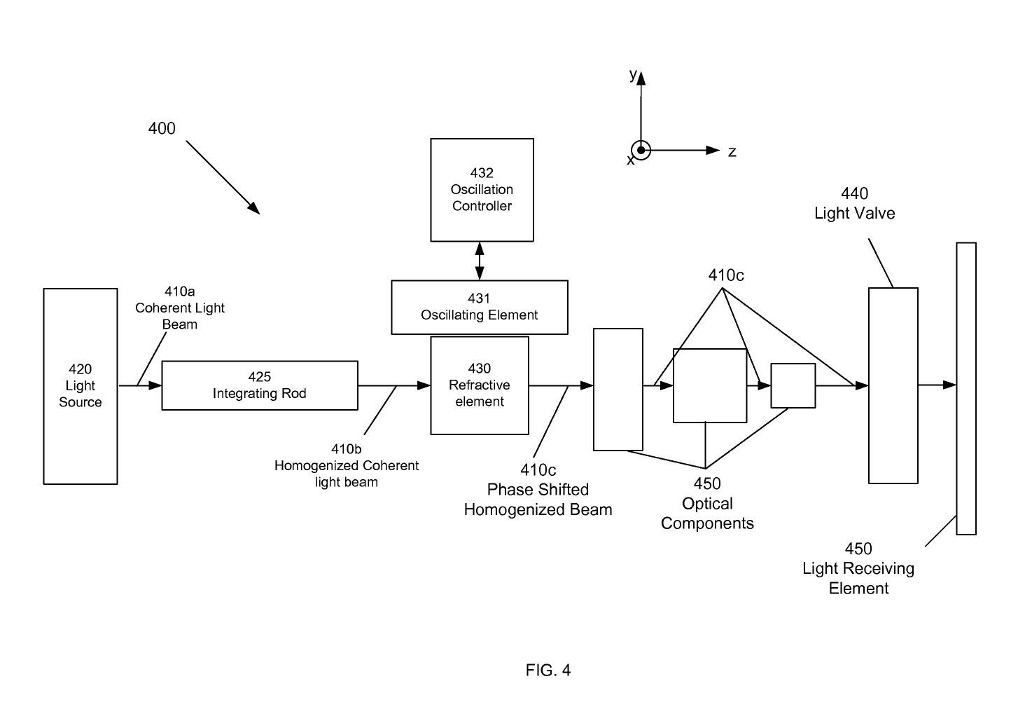

In an exemplary embodiment, the translation and/or rotation is preformed by an oscillating element, as described below in relation to FIG. 4. In a further contemplated embodiment, the oscillating element may have a piezoelectric element. The oscillating element is preferably in operative communication with an oscillation controller. In a preferred embodiment, the oscillation controller has a random number generator. The oscillation controller preferably regulates one or more of the oscillation frequency and amplitude of the oscillating element. Preferably, the oscillating element causes the refractive element to translate and/or rotate randomly.

As previously discussed, the translation and/or rotation of the refractive element preferably causes the rays to constantly pass through different portions of the refractive element. As a result, the phase shift of a ray relative to other rays is constantly and randomly varying as the rays pass through different portions and propagate different distance through the refractive element. Therefore, the interference pattern is not static. The interference pattern preferably becomes homogenized, resulting in a significantly reduced observable speckle phenomenon.

In further contemplated embodiments, the prism is preferably designed to have a small beam deviation due to refraction relative to the beam diameter. The optical system is preferably designed such that a small departure from the original footprint of the light beam as emanated from the light source does not affect the optical imaging of the light onto a receiving surface.

FIG. 4 illustrates an optical system 400 according to a preferred embodiment of the present invention. The optical system 400 preferably comprises a light source 420. The light source 420 preferably emanates a coherent light beam 410a. In a contemplated embodiment, the light source 420 is preferably a laser. Light beam 410a emanated from the light source 420 preferably passes through a lens and integrating rod 425, which may homogenize the light beam 410a such that the cross section of coherent homogenized light beam 410b matches that of the integrating rod 425. The system 400 can further include a refractive element 430. The refractive element 430 is preferably substantially similar to the refractive element 230, 330, or other refractive elements contemplated and described above. From the integrating rod 425, the coherent homogenized light beam 410b preferably passes through a refractive element 430, and the coherence of the rays is preferably eliminated as the rays are phase shifted and a phase shifted homogenized light beam 410c emanates from the refractive element 430. The light beam 410c preferably exits the refractive element 430 and propagates approximately parallel to the propagation axis of light beam 410b.

The refractive element 430 is preferably translated and/or rotated by an oscillating element 431. The oscillating element 431 is preferably a piezoelectric element. The oscillation parameters of the oscillating element 431 are preferably regulated by an oscillation controller 432. The oscillation parameters preferably include the frequency and amplitude of oscillation. The oscillation controller 432 preferably randomly varies the one or more oscillation parameters. In a contemplated embodiment, the oscillation controller 432 preferably includes a random number generator. As the refractive element 430 is randomly oscillated, the degree of phase shift between respective rays of the beam 410 varies temporally. In other contemplated embodiments, the oscillating element 431 may be a fan causing vibrations or other oscillating device and its parameters may be constant.

The system 400 further includes other optical elements 450 for focusing and manipulating the beam 310c as necessary for projection. The beam 410c is ultimately projected through a light valve 440. The light valve 440 preferably comprises a plurality of pixels that are energized by rays of the beam. The randomly varying phase shift induced by the refractive element 430 creates a randomized interference pattern on a light receiving element 450 beyond the light valve 440 resulting in a significantly reduced speckle phenomenon. According to an exemplary embodiment, the light receiving element may be a screen upon which a viewer observes and image being projected. In other contemplated embodiments, the light receiving element 250 can be a diffusive material onto which an image may be projected or through which the image may pass, enabling a viewer to observe and image.

In other contemplated embodiments, the refractive element 430 may be disposed in a different position in the system 400. For example, the refractive element 430 may be disposed between the light source 420 and the integrating rod 420. In further contemplated embodiments, the refractive element 430 may be used in an system other than system 400, wherein reduction of speckle phenomenon caused by coherent light is desired.

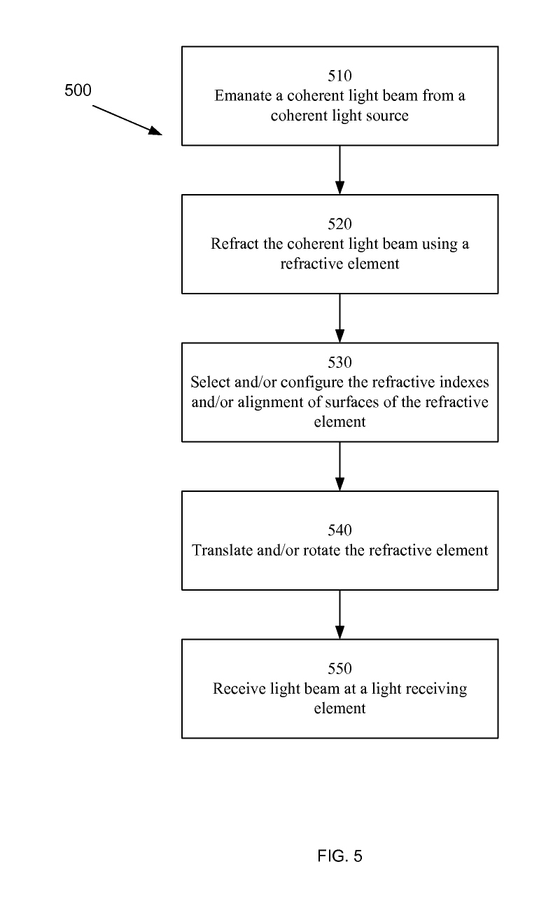

FIG. 5 illustrates a flowchart 500 of a method for inducing temporally varying relative phase shift in rays emanating from a coherent light source according to an exemplary embodiment of the present invention. In a preferred embodiment, the method employs the refractive element and/or system of the above described embodiments. At 510 a coherent light source emanates a coherent light beam. At 520 a refractive element refracts the coherent beam such that the propagation axis of a light ray exiting the refractive element is approximately parallel to the propagation axis of the ray entering the refractive element and two or more rays refracted by the refractive element undergo relative phase shift. In accordance with a preferred embodiment, at least one of a first refractive index a first component of the refractive element and a second refractive index of a second component of the refractive element, and at least one of the first planar surface or second planar surface of the first component or third planar surface or fourth planar surface of the second component are selected or configured at 530 such that the propagation axis of a light ray exiting the refractive element is approximately parallel to the propagation axis of the ray entering the refractive element and two or more rays refracted by the refractive element undergo relative phase shift.

At 540 the refractive element is translated or rotated relative to a first line defined by the intersection of at least two planes defined by at least two surfaces of the refractive element. In accordance to a preferred embodiment, the refractive element is preferably translated in a direction that is substantially not parallel and not perpendicular to the first line, the first line being parallel to a second surface of the refractive element, the first surface and the second surface intersected by the light ray. In accordance to a preferred embodiment, the refractive element is rotated about a rotational axis, the rotational axis being substantially parallel to the propagation axis of the ray entering the refractive element.

At 550, the light beam is received at a light receiving element, wherein the light beam creates an interference pattern on the surface of the light receiving element, the interference pattern varying temporally due to the translation or rotation of the refractive element. In other contemplated embodiments, the method of the present invention includes any of the steps described above in relation to the construction and implementation of the refractive element and system described above.

While the various embodiments of this invention have been described in detail with particular reference to exemplary embodiments, those skilled in the art will understand that variations and modifications can be effected within the scope of the invention as defined in the appended claims. Accordingly, the scope of the various embodiments of the present invention should not be limited to the above discussed embodiments, and should only be defined by the following claims and all applicable equivalents.

1. A refractive device inducing temporally varying relative phase shift in rays emanating from a coherent light source, the device comprising:
a refractive element having a geometric configuration and refractive properties such that the propagation axis of a light ray exiting the refractive element is approximately parallel to the propagation axis of the ray entering the refractive element and two or more rays refracted by the refractive element undergo relative phase shift, the refractive element having an isotropic refractive index; and
an oscillating element oscillating the refractive element relative to the propagation axis of rays entering the element.

2. The refractive device of claim 1, the refractive element further comprising:
a first component having a first refractive index and a first planar surface defining a first plane and a second planar surface defining a second plane; and
a second component having a second refractive index a third planar surface defining a third plane and a fourth planar surface defining a fourth plane.

3. The refractive device of claim 2, the first refractive index selected such that rays passing through the refractive element are refracted and undergo a relative phase shift.

4. The refractive device of claim 2, the first planar surface aligned such that rays passing through the refractive element are refracted and undergo a relative phase shift.

5. The refractive device of claim 2, wherein the first refractive index is not equal to the second refractive index.

6. The refractive device of claim 1, wherein oscillating the refractive element comprises translating the refractive element in a plane perpendicular to the propagation axis of rays entering the refractive element.

7. The refractive device of claim 1, wherein oscillating the refractive element comprises
rotating the refractive element about a rotational axis, the rotational axis parallel to the propagation axis of the ray entering the refractive element.

8. The refractive element of claim 2, wherein a light ray entering the refractive element intersects the first planar surface, the second planar surface, the third planar surface, and the fourth planar surface, and at least one of the second planar surface, third planar surface, and the fourth planar surface are not parallel to the first planar surface.

9. The refractive element of claim 2, the oscillating element translating the refractive element in a direction not parallel and not perpendicular to a line defined by the intersection of the first plane and the second plane.

10. A system for inducing temporally varying relative phase shift in rays emanating from a coherent light source, the system comprising:
a coherent light source for emanating a coherent beam of light;
a light valve having a plurality of pixels;
a refractive element having a geometric configuration and refractive properties such that the propagation axis of a light ray exiting the refractive element is approximately parallel to the propagation axis of the ray entering the refractive element and two or more rays refracted by the refractive element undergo relative phase shift, the refractive element comprising a first component having a first refractive index and a first planar surface defining a first plane and a second planar surface defining a second plane and a second component having a second refractive index a third planar surface defining a third plane and a fourth planar surface defining a fourth plane, the first, second, third, and fourth planar surfaces arranged to be intersected by the propagation axis of the light beam, the first plane not parallel to the second place and the third plane not parallel to the fourth plane; and
an oscillating element oscillating the refractive element relative to the propagation axis of rays entering the refractive element.

11. (canceled)

12. The refractive device of claim 10, the first refractive index selected such that rays passing through the refractive element are refracted and undergo a relative phase shift.

13. The refractive device of claim 10, the first planar surface aligned such that rays passing through the refractive element are refracted and undergo a relative phase shift.

14. The system of claim 10, the oscillating element translating the refractive element in a direction not parallel and not perpendicular to a line defined by the intersection of the first plane and the second plane.

15. The system of claim 10, wherein the coherent light source is one or more monochromatic lasers and the light valve is one of a liquid crystal display element, a liquid crystal on silicon element, or a digital light processing element.

16. A method for inducing temporally varying relative phase shift in rays emanating from a coherent light source, comprising:
emanating a coherent light beam from a coherent light source along an axis of propagation;
refracting the coherent light beam emanating from the coherent light source using a refractive element such that the propagation axis of a light ray exiting the refractive element is approximately parallel to the propagation axis of the ray entering the refractive element and any ray refracted by the refractive element is temporally phase shifted relative to each of the other rays in the beam;
oscillating the refractive element relative to a line defined by the intersection of at least two planes defined by at least two surfaces of the refractive element; and
receiving the light beam at a light receiving element, wherein the light beam creates an interference pattern on the surface of the light receiving element, the interference pattern varying temporally due to the oscillation of the refractive element.

17. The method of claim 16, further comprising selecting a first refractive index of a first component of the refractive element.

18. The method of claim 16, further comprising configuring a first planar surface of a first component of the refractive element.

19. The method of claim 16, wherein oscillating the refractive element comprises translating the refractive element in a direction that is not parallel and not perpendicular to a line defined by the intersection a first plane and a second plane, the first plane defined by a first planar surface of the refractive element and the second plane defined by a second planar surface of the refractive component, the first surface and the second surface intersected by the light ray.

20. The method of claim 16, further comprising rotating the refractive element about a rotational axis, the rotational axis substantially parallel to the propagation axis of the ray entering the refractive element.
